(19) United States
(12) Patent Application Publication
(10) Pub. No.: US 2012/0304708 A1
(43) Pub. Date: Dec. 6, 2012

(54) Pallet and Crate Seal and Method for Securing a Pallet or Crate

(75) Inventor: Koorosh Vafadari, Katy, TX (US)

(73) Assignee: Koorosh Vafadari, Katy, TX (US)

(21) Appl. No.: 13/463,195

(22) Filed: May 3, 2012

Related U.S. Application Data
(60) Provisional application No. 61/519,818, filed on May 31, 2011.

(51) Int. Cl. E05B 73/00

(52) U.S. Cl. 70/14

(57) ABSTRACT

Method and apparatus for securing a pallet, crate, or similar shipping containers against pilferage is disclosed. This seals is from now on referred to as a Pallet Seal. A pallet seals is comprised of one or more parts, having one or more locking devices. The seal can be secured against the clip on the pallet banding, completely covering and protecting the clip from tampering. The seal can have specific seal number and marking, color, or other features that makes it almost impossible to duplicate. Further the seal can have the capability to include RFID tags, Bar Code, and or custom marking and can be applied to the banding clips without a use of any tool or secondary seal or number.

### CROSS REFERENCE TO RELATED APPLICATIONS

The present application claims priority to co-pending U.S. Provisional Patent Application Ser. No. 61/519,818 filed on May 31, 2011, this application is incorporated herein in its entirety.

### FIELD

The present embodiments relate to securing a shipping pallet or crate.

### BACKGROUND

A need exists for a method or an apparatus to properly secure the clip on the banding used on pallets and crates in order to prevent tampering of its contents.

Everyday billions of dollars in goods are shipped around the world via air, ocean, truck, or rail. Security and protection of cargo is a major issue for shippers, carriers, insurance companies, end-users, and now TSA and national security.

Therefore, a need exists for an apparatus that allows shippers to protect cargo, maintain chain of custody through special and unique serial numbering, prevent clip from attack, and can be applied to existing clips on banding without use of a tool.

Therefor a need exists for an apparatus to secure and protect the contents of pallet and crate shipments from pilferage.

The present embodiments meet these needs.

### BRIEF DESCRIPTION OF THE DRAWINGS

The detailed description can be better understood in conjunction with the accompanying drawings as follows:

FIG. 1: Pallet and Crate Seal—Open view of Cover and Base

FIG. 2: Open view of band and clip situated inside the seal

FIG. 3: Open view of Seal Base

FIG. 4: Top view of Seal Base

FIG. 5: End Cross—Section view of Seal Base showing hinge, landing, and lock

FIG. 6: End Cross—Section view of Seal Base showing locking features

FIG. 7: Frontal Cross—Section view displaying Cover security fin

FIG. 8: Frontal Cross—Section view displaying locking system

FIG. 9: Top view of Seal Cover showing various security features

FIG. 10: Side view of Seal Cover showing various security features

FIG. 11: View of Seal showing applied clip to banding

FIG. 12: Shows a typical pallet or crate and location of banding and clip

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

The present embodiments relate to a pallet and crate seals which can be applied to a banding clip in order to secure the banding and hence the pallet or crate.

While these embodiments have been described with emphasis on the embodiments, it should be understood that within the scope of the appended claims, the embodiments might be practiced other than as specifically described herein.

The G2G Pallet Seal can have one, two or more sections of plastic, metal, or other suitable material, with either a male and female part or a single locking part which can enclose and protect the pallet clip. The size of the seal produced can vary depending on the size of the clip being applied to the banding.

Each seal can have one or more parts that when applied can create a self-locking device protecting the clip on the band. The current two-piece version showed has interlocking male and female parts.

Once the clip has been securely positioned inside the seal, then the seal can be closed by applying pressure to the top and bottom portion of the seal allowing the locking devices to engage and secure the seal.

After the clip has been applied to a banding on a pallet or crate, then the G2G Seal can be applied to the clip by simply sliding it under the clip until the clip is situated inside the seal and then the seal is closed.

A special barcode and or serial numbering prevent duplication of the seal. Once the seal is closed the clip cannot be attacked and hence the banding is secured. The banding can now be removed only by cutting the banding and the clip cannot be accessed unless by destroying the seal hence indicating tampering.

FIG. 1 depicts an embodiment of the seal to include a Cover 1 and a Base 2.

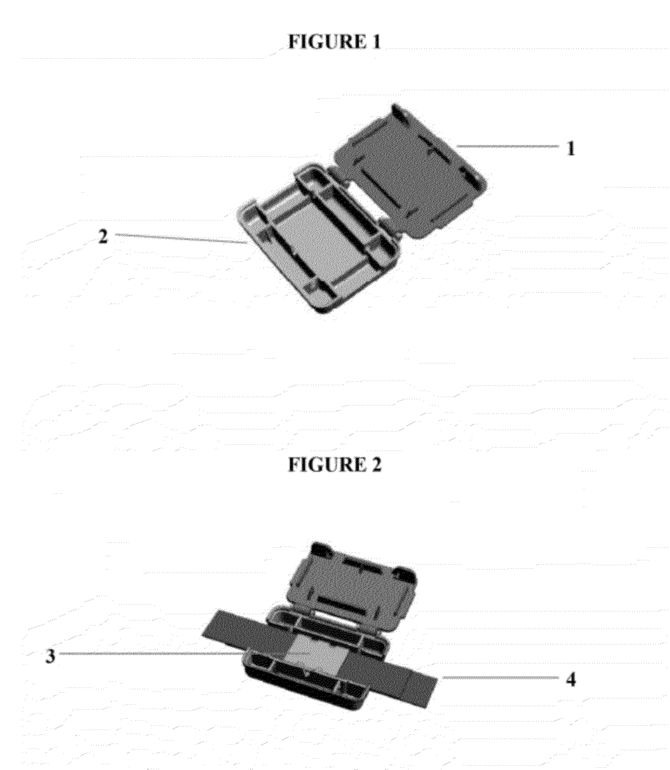

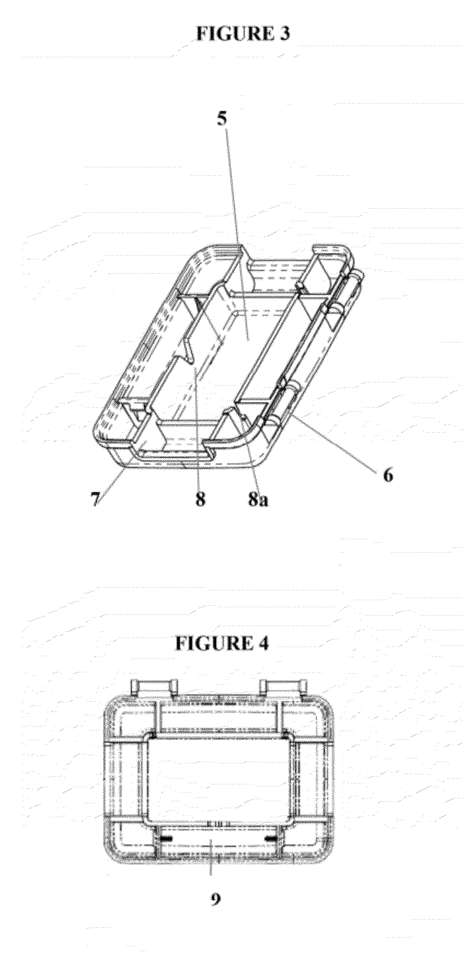

In FIG. 2 the Clip 3 is applied to Banding 4 and placed inside the designated location inside recessed area 5 of seal base as indicated in FIG. 3.

FIG. 3 shows the recessed area 5 where the clip will reside. Further hinge 6 allows easy movement of Cover 1 and Base 2 to allow seal to close without breaking before application. In addition interior wall 7 protects against attempts to pick the locking system from the opening where banding is passed through Base 2. Finally a special cavity 8 is added so that fin 23 shown in FIG. 9 can rest to secure against side to side movement.

In FIG. 4 which is the top view of the seal Base 2, we can clearly see the locking system being protected in area 9 with interior wall 7 preventing tampering.

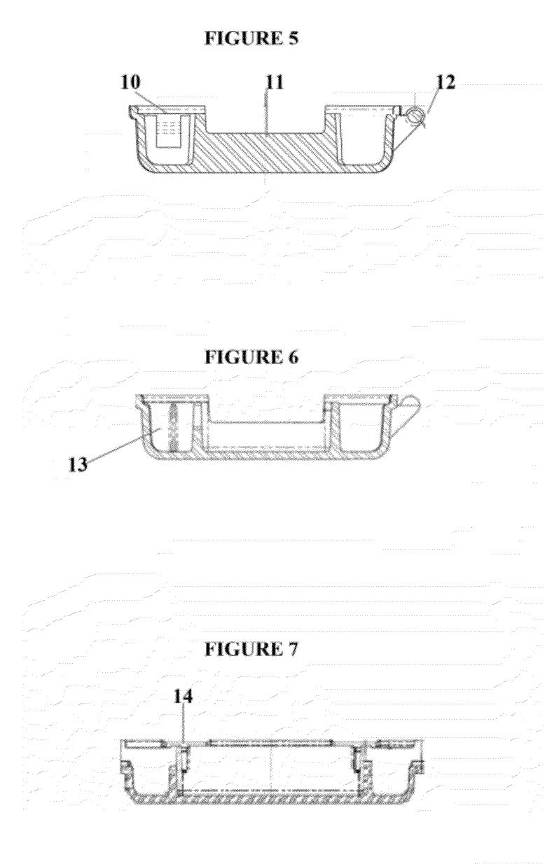

Cross section of FIG. 5 of Seal shows the Seal Cover 1 recessed into Seal Base 2. Further clip landing area 11 is shown as well as closed hinge 12 which allows for easy closer of seal and prevents against tampering. The closed hinge 12 is constructed using special material that will break if a screw driver or another object is used to force open the seal, hence indicating tampering.

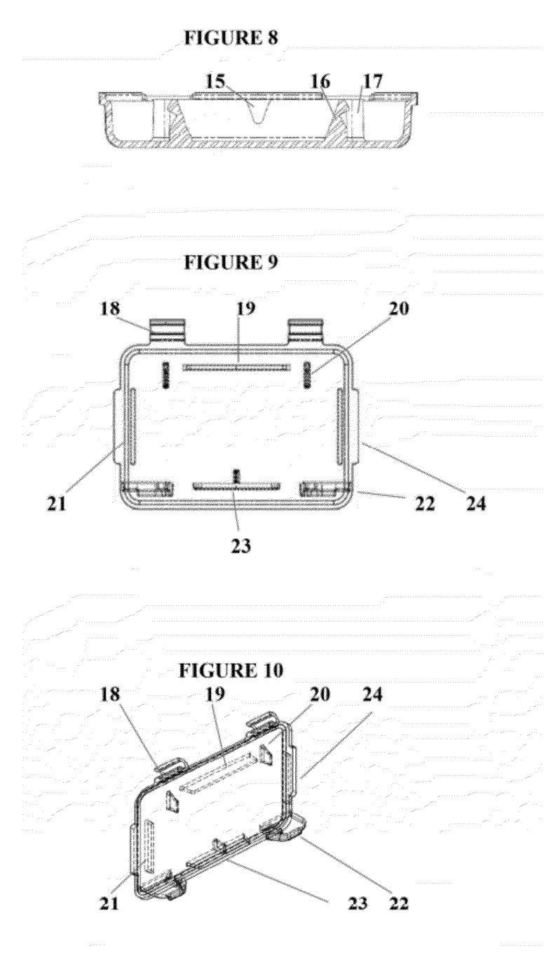

Once the seal is closed in FIG. 6, 13 shows the locking system cross section as a result of the female locking body 17 shown in FIG. 8 on seal Cover 1 being forced down into Base 2 engaging with the hook on the male locking part 16 in FIG. 8.

In FIG. 7 the seal Cover 1 has protruding fins 14 that when seal is closed is lowered into the inside section of seal Base 2 recessed area 5, pushing against interior wall 7. This helps prevent any tampering of the locking system through banding entrance and keeps the Clip 3 secure in the recessed area 5.

Once the seal is closed in FIG. 8, male fin 15 on seal Cover 1 is placed in the special

Cavity 8 in Base 2 and female locking body 17 is locked into male locking part 16 forming the closed seal.

FIG. 9 depicts a view while FIG. 10. Shows the side view of the bottom of the seal

Cover 1 showing various security features. Curved top portion of the hinge 18 is inserted into bottom hinge portion 6 forming the complete hinge 12. Two security walls 23 and 19 the same as in shown in 14 protect the locking and hinge mechanism from attack. Upon seal closure special security fin 20 lands in special cavity recess 8a in FIG. 3. This prevents the cover 1 from moving in Base 2 and the fin will break if attempt is made to force the cover off therefore indicating tampering. Special protruded wall 21 on Cover 1 is pushed against the banding 4 eliminating any gap between the Banding 4 and the seal body therefore eliminating access to Clip 3. The inner walls of recessed area 5 along with this protruded wall 21 will hold the Clip 3 securely in place in recessed area 5. The female locking arm 22 that is the same as 17 shown in FIG. 8 is shown to secure the lock. Finally the extended lip 24 which is located on both seal Cover 1 and Base 2 will extend the seal security body.

This helps prevent any used of screw driver or tool to try and force the clip 3 from its recessed area 5. If an attempt is made the extended lip 24 will indicate tampering.

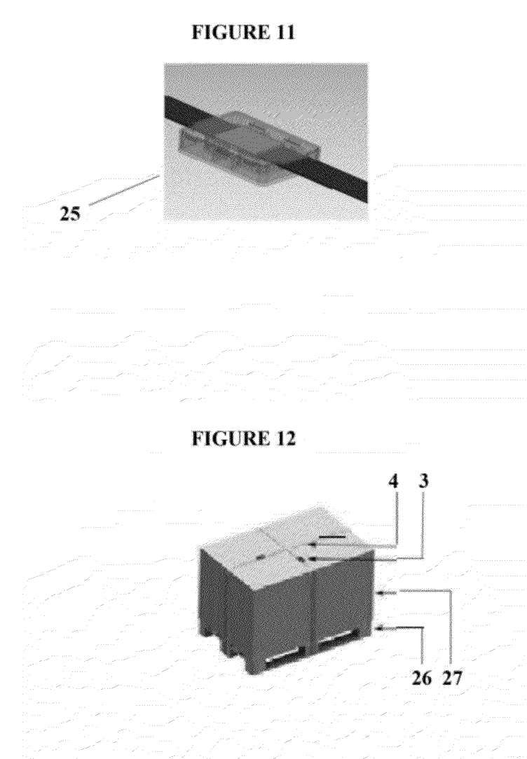

FIG. 11 shows the closed and applied seal showing the Clip 3 enclosed in the seal 25. The seal can also have unique markings, bar coding, coloring, and numbering in addition to optional RFID or other security measure in order to prevent counterfeiting or tampering.

Finally FIG. 12 indicates location of a typical Pallet 26 or Crate 27 containing the Clip 3 and Banding 4.

When cargo is ready to be shipped boxes are usually placed on a pallet, crate or containers, and then banding is secured by a metal clip and applied to secure the cargo. After the banding is applied then the seal is applied to the clip enclosing and protecting the clip. The seal is now secured and cannot be removed except by destroying the seal or cutting the banding where tampering of cargo is indicated.

The locking system has been designed in a way to provide maximum protection against tampering. Features have been included that can prevent tampering using common tools. Material used to produce the product can include measure to prevent use of acids, or Freon to defeat the locking system.

Other measure such as bar coding, use of clear polycarbonate material, special marking and or bar codes, can provide additional security measures.

The above described embodiments of the present invention thereby accomplish the stated objectives by providing substantial theft proof method and apparatus for sealing shipping pallets, crates, and similar shipping containers.

While the invention has been described, disclosed, illustrated and shown in certain terms or certain embodiments or modifications that it has assumed in practice, the scope of the invention is not intended to be nor should it be deemed to be limited thereby and such other modifications or embodiments as may be suggested by teachings herein are particularly reserved especially as they fall within the scope of the breadth and scope of the claims here appended.

What is claimed is:

1. A security seal adapted to be attached to a shipping strap, having at least one body, said body having at least one locking device and containing unique marking and or serial number.

2. The security seal of claim 1, where said body contains at least one member, where as a member is either connected as one piece allowing the device to close as a closure and secured by use of a locking mechanism or design, or said body containing at least two members with each member having either at least one male or at least one female self-locking device used to interlock the two members.

3. The security seal of claim 2, where sealing device encapsulates the clip on the banding.

4. The security seal of claim 2, where said members each have special identification means that are unique, either related or unrelated to each other.

5. The security seal of claim 2, where said body consists of 1 or 2 members, and said members consist of one or more locking device(s), each member having unique marking and serial numbers means.

6. A method of protecting a shipment on a Pallet, crate, or similar shipping containers from pilferage by applying a security seal that encapsulates the strapping clip securing the Pallet.

7. The method of claim 6, where said step of applying the security seal includes positioning a bottom or first member of the security seal between the pallet wall, the strapping clip, and pallet strapping; and engaging the top or another member of the security seal into said first member by the locking mechanism of the security seal.
